(19) United States
(12) Patent Application Publication
(10) Pub. No.: US 2023/0000001 A1
(43) Pub. Date: Jan. 5, 2023

(54) ASSEMBLED GARDEN TOOL

(71) Applicant: Weinan WU, Taiyuan (CN)

(72) Inventor: Weinan WU, Taiyuan (CN)

(21) Appl. No.: 17/364,781

(22) Filed: Jun. 30, 2021

(51) Int. Cl. A01B 1/22; A01B 1/08; A01B 1/10

(52) U.S. Cl. CPC A01B 1/227; A01B 1/08; A01B 1/10

(57) ABSTRACT

An assembled garden tool, including a tine, a base, and a tenon plate. The tine includes a blade part and a connecting part, and the connecting part has a mortise, and the tenon plate includes a tenon engaging with the mortise. The base has a slot, and the connecting part is inserted into the slot, the base is has a through hole corresponding to the mortise, the tenon and the mortise forms a mortise and tenon joint while the tenon extending through the through hole, which fixedly connects the tine and the base, such that each tines can be assembled quickly. Without the need for fixing tools for realizing connection, the tenon and mortise joint is used to facilitate disassemble, assemble, and replacement of the blades and tines. The tines can be used separately or in multiples, and the user can pry or rip the soil by gently prying the soil.

### TECHNICAL FIELD

The present disclosure relates to a garden tool, in particular to an assembled garden tool.

### BACKGROUND

Garden tools are equipment for maintenance of green landscape. They can be used to maintain lawns, hedges, and protect flowers and trees, and can also replace most manual labor mechanized tools. Classified according to use occasions, garden tools include garden tools and landscape tools. According to the object of use, it can also be divided into household tools and professional tools.

Garden tools include garden scissors, flower tools, such as garden flower tools and small flower tools.

Generally, the garden scissors include high branch scissors, hedge scissors, pruning scissors, multipurpose scissors, fruit picking scissors, flower scissors, grass scissors, etc. Landscape set flower tools (garden flower tools, small flower tools) include flower shovel, flower spade, flower rake, flower hoe, flower fork, and so on. Specifically, there can be two-headed flower hoe, flat hoe, flat rake, three-tooth flower hoe, three-tooth flower rake, hoe rake, hoe pick, large flower shovel, small flower shovel, three-shaped flower shovel, flat flower fork, six tooth flower rake and so on.

Generally, the conventional tools for prying or ripping mostly have a rake-type structure and are integrated, occupying a large space, and are not easy to disassemble, carry or store; and some detachable products are too complex in structure, cumbersome to disassemble and easy to loose, which affects their use.

### SUMMARY

The present disclosure is aim to provide an assembled garden tool, which realizes that each of the tines can be assembled quickly. Without the need for fixing tools such as screws, nails, glue for realizing connection, and the mortise and tenon structure is used to facilitate detachment, assembly, and replacement of the blades and tines. The tines or blades can be used separately or in multiples, and the user can pry or rip the soil by gently prying the soil.

In order to achieve the above objective, the present disclosure provides the following technical solutions:

An assembled garden tool, including a tine, a base, and a tenon plate. The tine includes a blade part and a connecting part, and the connecting part has a mortise, and the tenon plate includes a tenon for engaging with the mortise. The base has a slot, and the connecting part is inserted into the slot, the base is has a through hole corresponding to the mortise, the tenon and the mortise forms a mortise and tenon joint while the tenon extending through the through hole, and the mortise and tenon joint fixedly connects the tine and the base.

Additionally, a plurality of the slot are defined, and the slots are evenly arranged along a lateral direction of the base, the tenon includes a tongue and/or a head, and the mortise includes a groove and/or a hole. The groove engages with the tongue and forms the mortise and tenon joint, and the hole engages with the head and forms the mortise and tenon joint.

Additionally, the slot includes an edge slot. A lateral slot is located on an end of the base, and a first through hole is located on the lateral slot, and the first through hole is in communication with the edge slot. The connecting part is inserted into the edge slot, the first through hole is corresponding to the hole of the connecting part, and the head and the hole form the fixed connected mortise and tenon joint with an interference fit while the head extending through the first through hole.

Additionally, two edge slots are located on both ends of the base. Both ends of the base are located with the lateral slot and the first through hole extending the corresponding edge slot, and the head of the tenon plate and the hole form the fixed connected mortise and tenon joint with the interference fit while the head of the tenon plate extending through the first through hole.

Additionally, the slot further includes a middle slot, a main slot is located on the base, the position of the main slot is corresponding to the position of the middle slot, and a second through hole is located on the main slot, and the second through hole is in communication with the main slot. The connecting part is inserted into the main slot, the second through hole is corresponding to the groove of the connecting part, and the tongue and the groove form the fixed connected mortise and tenon joint with the interference fit while the tongue of the tenon plate extending through the second through hole.

Additionally, a plurality of the middle slots are located on the base, and each of the middle slots is corresponding to one of the main slots and one of the tenon plates, each of the connecting parts is inserting into the corresponding middle slot, each of the main slots are defined with the second through hole extending through the corresponding middle slot, and the tongue of each of the tenon plates is capable of extending through the corresponding second through hole, and each of the tongues and the corresponding groove form the fixed connected mortise and tenon joint with the interference fit.

Additionally, the base is a cylinder with a cross section of a major circular segment.

Additionally, the base with the cross section of the major circular segment comprises a arc part and a plane part, and the slot is defined on the plane part.

Additionally, according to an outer edge shape of the tenon plate, the tenon plate comprises a major circular segment tenon plate, a circular plate, or a rectangular tenon plate. The head includes a cylinder head and the tongue includes a cubic tongue.

Additionally, the inner edge shape of the lateral slot is identical and corresponding to the outer edge shape of the tenon plate.

Additionally, the inner edge shape of the lateral slot and the outer edge shape of the tenon plate are both major circular segment.

Additionally, the shape of the first through hole in the lateral slot is identical and corresponding to a shape of the cross-section of the head in the first through hole.

Additionally, the shape of the first through hole and the shape of the cross-section of the head inserted in the first through hole are both circular.

Additionally, the inner edge shape of the main slot is identical and corresponding to the outer edge shape of the tenon plate.

Additionally, the inner edge shape of the main slot and the outer edge shape of the tenon plate are both circular.

Additionally, the shape of the second through hole in the main slot is identical and corresponding to a shape of the cross-section of the tongue in the second through hole.

Additionally, the shape of the second through hole and the shape of the cross-section of the tongue inserted in the second through hole are both rectangular.

Additionally, the tenon plate further includes a fixing pin, and the main slot is defined with a fixing hole corresponding to the fixing pin, the tenon plate is fixedly inserted with the base while the fixing pin of the tenon plate is inserting into the fixing hole.

Additionally, the tine further comprises a tip part, and the connecting part of the tine is provided on an end of the tine and the tip part is provided on another end of the tine.

Additionally, the base further has a reinforcing rib for fixing the base.

Accordingly, the present disclosure provides an assembled garden tool, which can quickly replace any of the damaged tines, which is different from all products of the conventional garden tools, and no conventional connecting tools, such as screws, nails, or glues, are used for connecting. Instead, the mortise and tenon joint are used, it is easy to disassemble, assemble and replace after damage. The tines or blades can be used separately or in multiples, and the user can pry or rip the soil by gently prying the soil.

### BRIEF DESCRIPTION OF THE DRAWINGS

To illustrate the technical solutions according to the embodiment of the present invention or in the prior art more clearly, the accompanying drawings for describing the embodiment or the prior art are introduced briefly in the following. Apparently, the accompanying drawings in the following description are only some embodiment of the present invention, and persons of ordinary skill in the art can derive other drawings from the accompanying drawings without creative efforts.

FIG. 1 is an exploded view of the assembled garden tool of the present disclosure;

FIG. 2 is a perspective view of the base of the assembled garden tool of the present disclosure;

FIG. 3 is a perspective view of the base of the assembled garden tool of the present disclosure showing the inner structure of the slot;

FIG. 4 is a side view of the tine of the assembled garden tool of the present disclosure;

FIG. 5 is a perspective view of the connecting part of the tine of the assembled garden tool of the present disclosure;

FIG. 6 is a perspective view of the major circular segment tenon plate of the assembled garden tool of the present disclosure; and

FIG. 7 is a perspective view of the circular tenon plate of the assembled garden tool of the present disclosure.

### REFERENCE NUMBER

1—base, 2—tine, 3—major circular segment tenon plate, 4—circular tenon plate, 5—arc part, 6—plane part, 12—edge slot, 13—middle slot, 14—reinforcing rib, 15—lateral slot, 16—main slot, 17—first through hole, 18—fixing hole, 19—second through hole, 21—groove, 22—hole, 23—connecting part, 24 blade part, 25—tip part, 31—head, 41—tongue, 42—fixing pin.

### DETAILED DESCRIPTION OF THE EMBODIMENTS

The present disclosure will be further described in detail below with reference to the drawings. Each embodiment is provided by way of explanation of the present disclosure instead of limiting the present disclosure. It will be clear to those skilled in the art that modifications and variations can be made in the present disclosure without departing from the scope or spirit of the disclosure. For example, features shown or described as part of one embodiment can be used in another embodiment to yield a further embodiment. Therefore, it is expected that the present disclosure includes such modifications and variations that fall within the scope of the appended claims and their equivalents.

The terms such as “upper”, “inner”, “center”, “left”, “right”, and “bottom” cited in this specification are only for ease of description and are not intended to limit the scope of the present disclosure. The change or adjustment of the relative relationship of the elements, without substantial changes to the technical content, shall also be regarded as the scope within which the present disclosure can be implemented. Unless defined otherwise, the term such as “fixed to” or “connected to should be understood in broad sense. For example, when an element is referred to as being “fixed to” another element, it may be fixedly, detachably, or integrally connected on the other element; it may also be mechanically or electrically connected on the other element, and it may be directly on the other element or there may be a centered element. For those of ordinary skill in the art, the specific meaning of the above terms in the present disclosure may be understood according to the specific situation.

One or more embodiment are shown according to the accompanying drawings. The detailed description uses reference numbers and letter designations to refer to features in the drawings. Similar or alike reference numbers in the drawings and description have been used to refer to similar or alike parts of the present disclosure. In addition, the terms “first”, “second”, or the like are only used for descriptive purposes, and cannot be understood as indicating or implying relative importance or implicitly indicating the number of indicated technical features.

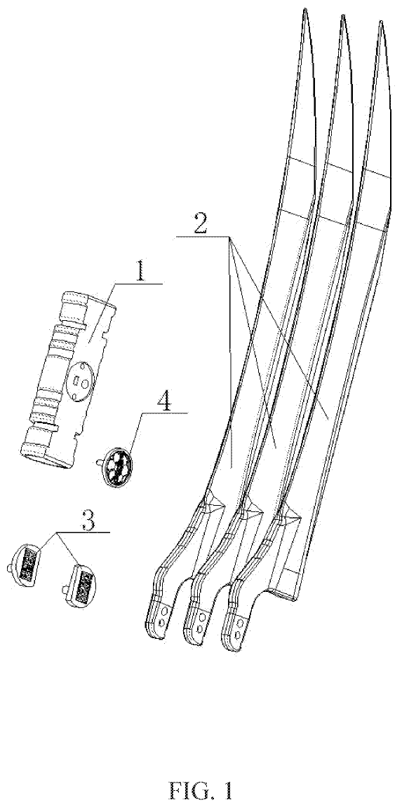

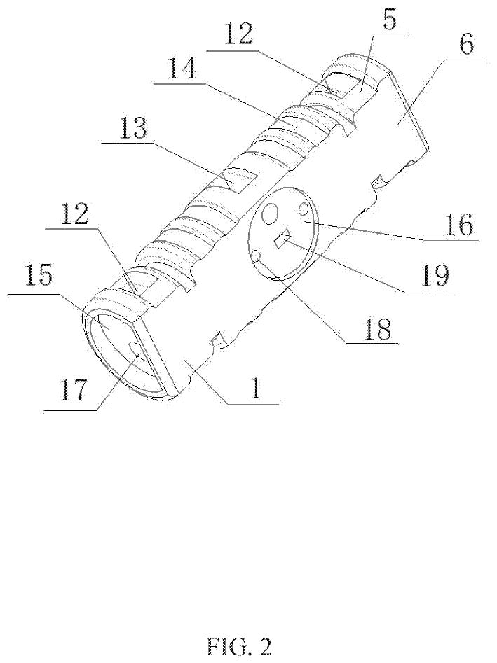

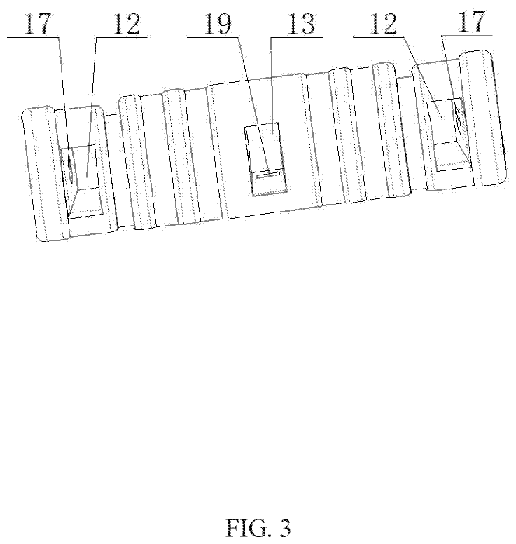

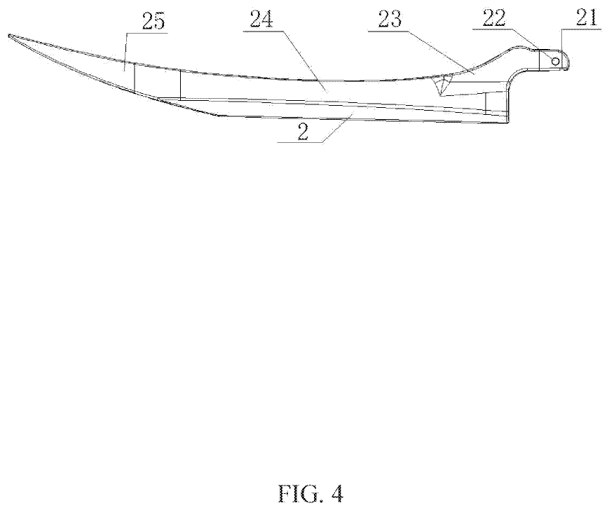

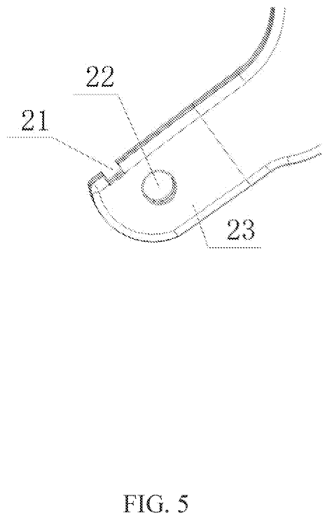

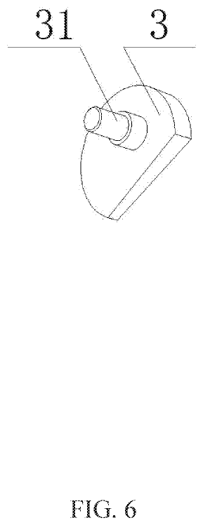

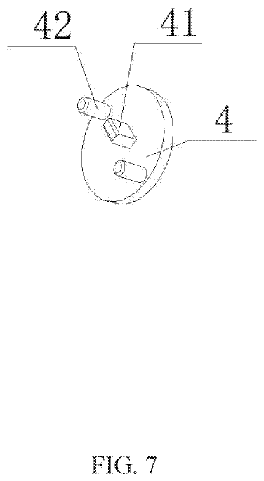

Referring to FIG. 1 to FIG. 7, the embodiment of the present disclosure provides an assembled garden tool, including a base 1, a tine 2, and a tenon plate. The base has a cross-sectional shape of major circular segment, which is more suitable for handling, that is, the shape of major circular segment can fit the shape of human palm, increasing the contact surface of the palm and the base, preventing from slipping. The tine 2 has a tip part 25, a blade part 24, and a connecting part 23. The tip of the tip part 25 can insert into the soil more easily, increasing the efficiency of prying. The connecting part 23 of the tine is located on one end of the tine 2, and the tip part 25 is located on another end of the tine 2. The base has a plurality of slots, and the slots are evenly arranged along a lateral direction of the base, the spacing between the slots range from 20 mm to 30 mm. Accordingly, the tines are evenly arranged, when garden tool is used, the density of tines and rakes to loosen the soil is even, and it is not easy to cause soil leakage. The base further has a reinforcing rib fixing the base, which can enforce the strength of the base 1, preventing the base from breaking due to the plurality of the slots. The base with the cross-sectional shape of major circular segment can be divided into an arc part 5 and a plane part 6, and the slots are located on the arc part 5 of the base. The connecting part 3 has a mortise, and the tenon plate has a tenon for engaging with the mortise. The tenon includes a tongue 41 or a head 31, and the mortise includes a groove 21 or a hole 22. The groove 21 forms a mortise and tenon joint with the tongue 41, and the hole 22 forms a mortise and tenon joint with the head 31. The connecting part 23 can be inserted into the slots, and the base 1 has through holes corresponding to the mortise, the tenon and the mortise forms a mortise and tenon joint while the tenon extending through the through hole, and the mortise and tenon joint fixedly connects the tine 2 and the base 1. The tines are corresponding to the slots on the base, such that each of the tines can be replaced separately. According to the embodiment, the tine is fixed to the base by the tenon plate, without using conventional connecting tools, such as screws, nails, or glues. Instead, the mortise-and-tenon joint are used, it is easy to disassemble, assemble and replace after damage. The tines or blades can be used separately or in multiples, and the user can pry or rip the soil by gently prying the soil. According to an outer edge shape of the tenon plate, the tenon plate can be a major circular segment tenon plate 3, a circular plate 4, or a rectangular tenon plate. The head 31 includes a cylinder head and the tongue 4 includes a cubic tongue.

The slot includes the edge slots 12. The two edge slots 12 are located on both ends of the base 1, respectively. Two lateral slots 15 are located on both ends of the base 1, and a first through hole 17 is located on each of the the lateral slot 15, and the first through hole 17 is in communication with the edge slot 12. The connecting part 23 is inserted into the edge slot 12, the first through hole 17 is corresponding to the hole 22 of the connecting part 23, and the head 23 of the major circular segment tenon plate 3 inserts through the first through hole 17, and the outer edge of the major circular segment tenon plate 3 clamps with the inner edge of the lateral slot 15. The head 31 and the hole 22 form the fixed connected mortise and tenon joint with an interference fit. The major circular segment tenon plate 3 and the base 1 both have an identical cross section shape of major circular segment, and the shape of the lateral slot 15 is corresponding to the shape of the major circular segment tenon plate 3. While the major circular segment tenon plate 3 is inserted into the lateral slot 15, the major circular segment tenon plate 3 is slightly higher than the inner edge of the lateral slot 15, such that the major circular segment tenon plate 3 can be plucked out from the lateral slot 15 if the tine is required to be replaced. Also, the major circular segment tenon plate 3 is installed in the lateral slot 15, which is more fitted to the end of the base 1, preventing the tenon plate from falling out easily.

The slot further includes a middle slot 13, and a main slot 16 is located on the plane part 6 of the base 1. The circular tenon plate 4 can be fitly inserted in the main slot 16 of the plane part 6 of the base, such that the tenon plate won't pick the user's hand while firmly hold. The shape of the main slot 16 is corresponding to the shape of the circular tenon plate 4. While the circular tenon plate 4 is inserted into the main slot 16, the circular tenon plate 4 is slightly higher than the inner edge of the main slot 16, such that the circular tenon plate 4 can be plucked out from the main slot 16 if the tine is required to be replaced.

The main slot 16 is located on a position corresponding to the middle slot 13, and the main slot 16 has a second through hole 19 inside, and the second through hole 19 is in communication with the middle slot 13. The connecting part 23 is inserting into the middle slot 13, and the second through hole 19 is corresponding to the groove 21 of the connecting part 23. The inner edge shape of the main slot 16 is identical and corresponding to the outer edge shape of the circular tenon plate 4, which are both circular. The shape of the second through hole 19 in the main slot 16 is identical and corresponding to the shape of the cross-section of the tongue 41 inserted in the second through hole 19, which are both rectangular. The tongue 41 of the circular tenon plate 4 is extending through the second through hole 19, and the tongue 41 forms a mortise and tenon joint with the interference fit with the groove 21. The circular tenon plate 4 further includes a fixing pin 42, and the main slot 16 is has a fixing hole 18 corresponding to the fixing pin 42, and the circular tenon plate 4 is fixedly inserted with the base 1 while the fixing pin 42 of the circular tenon plate 4 is inserting into the fixing hole 18 The fixing pin 42 is to fix the circular tenon plate 4 and the base 1, preventing the circular tenon plate 4 from falling out.

While using, the tine 2 is placed in the edge slot 12 or the middle slot 13, and the cylinder head 31 of the major circular segment tenon plate 3 is extending through the first through hole 17, and the cylinder head 31 of the major circular segment tenon plate 3 engages with the hole 22, so as to form the mortise and tenon joint with the interference fit. The tongue 41 of the circular tenon plate 4 corresponding to the middle slot 13 is extending through the second through hole 19, and the tongue 4 forms the mortise and tenon joint with the interference fit with the groove 21. Thus, the tine 2 and the base 1 form a fixedly connected mortise and tenon joint.

From the above description, it can be seen that the above-mentioned embodiments of the present disclosure achieve the following technical effects:

1. the base is a cylinder with a cross section of a major circular segment, which is conducive to the grip and fit of the palm, preventing from slipping.

2. Each of the tines is corresponding to an individual slot, such that the damaged tine can be replaced separately. The tines will not affect each other, and it is not necessary to replace all the tines at the same time, which saves resources.

3. The tine and the base are connected by the mortise and tenon joint, and the mortise and tenon joint is connected by the tenon plate. Therefore, it can effectively limit the twisting in all directions between the wooden pieces, while the conventional metal pieces such as iron nails could by easily twisted and affect the connecting angle. The mortise and tenon joint of the present disclosure will not be twisted.

The specific embodiments are only explanations of the present disclosure, and the embodiments are not intended to limit the present disclosure. The scope of this present disclosure is not limited to the content of the description, and its technical scope shall be determined according to the scope of the claims. Such that the protection scope of the present disclosure should be subject to the claims.

1. An assembled garden tool, comprising a tine, a base, and a tenon plate,
wherein the tine comprises a blade part and a connecting part, and the connecting part is defined with a mortise,
and the tenon plate comprises a tenon being capable of engaging with the mortise; and
the base is defined with a slot, and the connecting part is inserted into the slot, the base is defined with a through hole corresponding to the mortise, the tenon and the mortise forms a mortise and tenon joint while the tenon extending through the through hole, and the mortise and tenon joint fixedly connects the tine and the base.

2. The assembled garden tool according to claim 1, wherein
a plurality of the slot are defined, and the slots are evenly arranged along a lateral direction of the base,
the tenon comprise a tongue and/or a head, and the mortise comprises a groove and/or a hole;
the groove engages with the tongue and forms the mortise and tenon joint; and
the hole engages with the head and forms the mortise and tenon joint.

3. The assembled garden tool according to claim 2, wherein
the slot comprises an edge slot,
a lateral slot is defined on an end of the base, and a first through hole is defined on the lateral slot, and the first through hole is in communication with the edge slot; and
the connecting part is inserted into the edge slot, the first through hole is corresponding to the hole of the connecting part, and the head and the hole form the fixed connected mortise and tenon joint with an interference fit while the head extending through the first through hole.

4. The assembled garden tool according to claim 3, wherein
two edge slots are defined on both ends of the base; and
both ends of the base are defined with the lateral slot and the first through hole extending the corresponding edge slot, and the head of the tenon plate and the hole form the fixed connected mortise and tenon joint with the interference fit while the head of the tenon plate extending through the first through hole.

5. The assembled garden tool according to claim 3, wherein
the slot further comprises a middle slot,
a main slot is defined on the base, the position of the main slot is corresponding to the position of the middle slot, and a second through hole is defined on the main slot, and the second through hole is in communication with the main slot; and
the connecting part is inserted into the main slot, the second through hole is corresponding to the groove of the connecting part, and the tongue and the groove form the fixed connected mortise and tenon joint with the interference fit while the tongue of the tenon plate extending through the second through hole.

6. The assembled garden tool according to claim 5, wherein
a plurality of the middle slots are defined on the base, and each of the middle slots is corresponding to one of the main slots and one of the tenon plates, each of the connecting parts is inserting into the corresponding middle slot, each of the main slots are defined with the second through hole extending through the corresponding middle slot, and the tongue of each of the tenon plates is capable of extending through the corresponding second through hole, and each of the tongues and the corresponding groove form the fixed connected mortise and tenon joint with the interference fit.

7. The assembled garden tool according to claim 1, wherein
the base is a cylinder with a cross section of a major circular segment.

8. The assembled garden tool according to claim 7, wherein
the base with the cross section of the major circular segment comprises a arc part and a plane part, and the slot is defined on the plane part.

9. The assembled garden tool according to claim 3, wherein
according to an outer edge shape of the tenon plate, the tenon plate comprises a major circular segment tenon plate, a circular plate, or a rectangular tenon plate;
the head comprises a cylinder head; and
the tongue comprises a cubic tongue.

10. The assembled garden tool according to claim 9, wherein
a inner edge shape of the lateral slot is identical and corresponding to the outer edge shape of the tenon plate.

11. The assembled garden tool according to claim 10, wherein
the inner edge shape of the lateral slot and the outer edge shape of the tenon plate are both major circular segment.

12. The assembled garden tool according to claim 3, wherein
a shape of the first through hole in the lateral slot is identical and corresponding to a shape of the cross-section of the head in the first through hole.

13. The assembled garden tool according to claim 12, wherein
the shape of the first through hole and the shape of the cross-section of the head inserted in the first through hole are both circular.

14. The assembled garden tool according to claim 9, wherein
an inner edge shape of the main slot is identical and corresponding to the outer edge shape of the tenon plate.

15. The assembled garden tool according to claim 14, wherein
the inner edge shape of the main slot and the outer edge shape of the tenon plate are both circular.

16. The assembled garden tool according to claim 9, wherein
a shape of the second through hole in the main slot is identical and corresponding to a shape of the cross-section of the tongue in the second through hole.

17. The assembled garden tool according to claim 16, wherein
the shape of the second through hole and the shape of the cross-section of the tongue inserted in the second through hole are both rectangular.

18. The assembled garden tool according to claim 5, wherein
the tenon plate further comprises a fixing pin, and the main slot is defined with a fixing hole corresponding to the fixing pin, the tenon plate is fixedly inserted with the base while the fixing pin of the tenon plate is inserting into the fixing hole.

19. The assembled garden tool according to claim 1, wherein
the tine further comprises a tip part, and the connecting part of the tine is provided on an end of the tine and the tip part is provided on another end of the tine.

20. The assembled garden tool according to claim 14, wherein
the base is further provided with a reinforcing rib capable of fixing the base.
